(19) United States
(12) Patent Application Publication
(10) Pub. No.: US 2011/0056841 A1
(43) Pub. Date: Mar. 10, 2011

(54) SYSTEM AND METHOD FOR DIRECT CONVERSION OF SOLAR ENERGY TO CHEMICAL ENERGY

(75) Inventors: Brian L. WEHRENBERG, College Park, MD (US); Zehra Serpil GONEN WILLIAMS, Lanham, MD (US); Gregory D. COOPER, Arlington, VA (US); Zhiyun CHEN, Rockville, MD (US)

(73) Assignee: PIXELLIGENT TECHNOLOGIES, LLC, College Park, MD (US)

(21) Appl. No.: 12/878,272

(22) Filed: Sep. 9, 2010

Related U.S. Application Data
(60) Provisional application No. 61/241,250, filed on Sep. 10, 2009.

(51) Int. Cl. C25B 1/04; C25B 1/00; C25B 3/00; C07F 9/94; C07F 19/00

(52) U.S. Cl. 205/340; 556/30; 556/28

(57) ABSTRACT

Semiconductor nano-sized particles possess unique properties, which make them ideal candidates for applications in solar electrochemical cells to produce chemical energy from solar energy. Coupled nanocrystal photoelectrochemical cells and several applications improve the efficiency of solar to chemical energy conversion.

### CROSS-REFERENCES TO RELATED APPLICATIONS

This application claims the benefit of priority from provisional application No. 61/241,250 filed Sep. 10, 2009, incorporated herein by reference.

### FIELD

The technology herein relates to systems and methods of converting solar energy into chemical energy. More particularly, the technology herein relates to using coupled nanocrystal photoelectrochemical cells to efficiently convert the solar energy into chemical energy.

### BACKGROUND AND SUMMARY

### Solar Energy Conversion

Solar energy is the ultimate clean and renewable energy. The earth receives enough energy from the sun in one hour to equal the annual global energy consumption. Currently much effort in this area is focused on converting solar energy into electricity. This photovoltaic approach, however, imposes unnecessary limits on how solar energy can be used and stored.

One important reason is that solar power is intermittent by nature, influenced by the diurnal and seasonal cycles, weather, and geological location. The excess electricity produced during the peak hours, or electricity produced at a favorable location, needs to be stored, preferably in the form of chemical energy, for future use. A myriad of technologies exist to produce chemical energy from electricity, but this step reduces overall efficiency. Thus, there is a significant advantage in converting solar energy directly into chemical energy.

Chemical fuel is defined here as a chemical product of photoelectrochemical process(es), or of the photoelectrochemical process followed by a further processing of the initial product, that can be stored and used later as an energy source, including: molecular hydrogen, molecular oxygen, carbon monoxide, hydrocarbons and other organic molecules such as: alcohols, esters, ethers, etc.

A novel mechanism for directly converting solar energy to chemical fuels is described.

### Photoelectrochemical Cells (PEC)

In a photoelectrochemical cell, light energy is collected by an absorber (a transition metal complex, an organic dye molecule, a semiconductor, a sensitizer molecule on a semiconductor surface, etc.) and is converted into the electrochemical potential needed to drive the production of chemical fuel. These chemical reactions are known as reduction-oxidation or “redox” reactions.

Several considerations dictate the choice of a proper material for the absorber in the photoelectrochemical cell. The energy difference between the electronic ground state and first excited state (i.e., the highest occupied molecular orbital (HOMO) and lowest unoccupied molecular orbital (LUMO)) is called the HOMO-LUMO gap for a molecular species or the bandgap for a semiconductor. The energy gap of the absorber should be large enough to drive the fuel producing reactions but small enough to absorb a large fraction of light wavelengths incident upon the surface of the earth. For example, a UV photon would be sufficient to drive many fuel producing redox reactions, but unfortunately UV light makes up only about 4% of the solar radiation received at the surface of the earth. Additionally, the redox potentials of the photo-generated hole and electron in the absorber should be located such that the desired oxidation and reduction half-reactions are both accessible.

This means that for the example of the photoelectrochemical splitting of water (producing molecular oxygen and hydrogen from water), the photo-excited electron in the absorber should have a reduction potential greater than or equal to that necessary to drive the following reaction:

2H₃O⁺+2e⁻→H₂+2H₂O

which has a standard reduction potential of 0.0 V vs. the standard hydrogen electrode (SHE). The photo-excited hole (h⁺) should have an oxidation potential greater than or equal to that necessary to drive the following reaction:

6H₂O+4h⁺→O₂+4H₃O⁺

which has a standard oxidation potential of −1.23 V vs. SHE. Therefore, the absolute minimum energy gap for the absorber in a water splitting reaction is 1.23 eV. In reality, given overpotentials and loss of energy for transferring the charges to donor and acceptor states (described later), the minimum energy may be closer to 2.1 eV.

Some of the most promising photoelectrochemical approaches involve the use of heterogeneous reactions at bulk semiconductors surfaces. One of the characteristics of a semiconductor material is the bandgap in its electronic structure. The electronic energy band below the bandgap is called the valence band (VB) while the energy band above the bandgap is known as the conduction band (CB). Many physical properties of semiconductors can be explained by their bandgap. Its manifestation in optical absorption is that only photons with energy larger than or equal to the bandgap are absorbed. A photon with sufficient energy promotes an electron from the valence band to the conduction band, leaving an empty state, known as a hole, in the valence band. This electron-hole pair created by the absorption of a photon by the semiconductor is known as an exciton. Excited carriers in a semiconductor have a finite lifetime. After this time the semiconductor relaxes by the recombination of electrons and holes.

FIG. 1 shows an energy level diagram of a semiconductor with a bandgap (E_{g}). The valence and conduction band-edge energy levels of this semiconductor are labeled as Eᵥ and E_{c}, respectively. The electron (filled circle) is promoted from the valence band to the conduction band leaving a hole (open circle) in the valence band. The redox potentials for the desired reduction reaction and the oxidation reaction are shown as V_{Red} and Vₒₓ, respectively. After photo-excitation the electron and hole can recombine (101), or be used to carry out the reduction and oxidation reactions (102 and 103), respectively. On the left hand side of the diagram in FIG. 1, two energy axes have been shown for reference. Both axes are used to describe the location of the energy levels in the semiconductor and are in units of electron volts (eV). The far left axis (104) describes the internal energy of the levels with reference to the vacuum level while the other axis (105) is referenced to the SHE. On the right hand side of the diagram is the axis (106) showing the redox potentials, in Volts, of the species at the semiconductor/electrolyte interface also with reference to the SHE. When talking about the energy of electrons and holes as well as the energy levels in the semiconductor and the ligands it will be in units of eV and reported with respect to the SHE, and when talking about redox potentials it will be in units of Volts and also with respect to the SHE. Note that the diagram has been drawn so that energy is increasing with respect to the vacuum, as is usually the case in solid state physics. However, due to electrochemical conventions this means that the energy axis versus the SHE is oriented so that the energy increases in the downward direction. In order to show numbers on the axes, the axes in this diagram have been aligned so that the V_{red} and Vₒₓ line up with the standard redox potentials for the water splitting reactions described above. This however does not take away from the generality of this diagram and should not be taken to mean that the diagram has been drawn to scale. For the purposes of this particular non-limiting example, the relative location of energy levels will be discussed as they appear in this energy diagram. For example, it can be said that E_{c} is above Eᵥ, despite the fact that, with reference to SHE, E_{c}−Eᵥ<0 eV.

Simply trying to use the charge carriers (electron and hole) immediately after their photo-generation to produce the final product as shown in FIG. 1 may be problematic. Recombination of the electron and hole, labeled in FIG. 1 as (101), occurs by processes such as radiative relaxation and can often be quite rapid with respect to the fuel producing reduction/oxidation (redox) reactions. This inefficient charge separation may lead to a low overall efficiency for fuel production.

FIG. 2 shows a scheme to efficiently separate the charge carriers and keep them separated until the oxidation and reduction reactions are performed. An electron can be promoted from the valence band of a semiconductor, with a bandgap of E_{g}, to the conduction band. The energies of the valence and conduction band are denoted as Eᵥ and E_{c}, respectively. For efficient charge separation, something should act quickly to sequester the electron and hole and hold them until they can be used in the final redox reactions. These acceptor (A) and donor (D) states should necessarily lie energetically between the band edge states and the redox potentials of the fuel producing half-reactions, denoted as Vₒₓ for the oxidation reaction and V_{red} for the reduction reaction. After photo-excitation to the conduction band, the electron can quickly move to the acceptor state (202), whereas the hole can move to the donor state (203) preventing recombination of the charge carriers (201). Recombination between the electron and hole in the A and D states may be significantly less probable than for charge carriers in the semiconductor conduction and valence bands. The energy levels of the D and A should be close to the band edges (Eᵥ and E_{c}), with A slightly below E_{c} and D slightly above Eᵥ, as any energy difference between the band edge and the donor/acceptor states results in an efficiency loss for the system. The sequestration of the charges into these states should also physically separate the charges; otherwise other fast subsequent reactions may be needed to further prevent recombination. With the charge carriers in the donor and acceptor states, where they may be much more stable to recombination, they can be efficiently stored for use in the relatively slow reduction reaction (204) and oxidation reaction (205).

Many of the redox reactions of interest require multiple charges to produce fuel and the charge-wise reaction intermediates may be unstable. This may cause further problems in a scheme that tries to immediately use the photo-excited charges to produce the chemical fuels. Simply using the charges as they are created in the absorber makes the presence of multiple charges simultaneously available for a multi-charge concerted reaction unlikely. As an example, the oxidation of water to produce oxygen is a process which involves two molecules of water accepting 4 holes (h⁺) and losing 4 protons to make 1 molecule of oxygen. The reaction, along with the standard redox potential, can be written as:

6H₂O+4h⁺=>O₂+4H₃O⁺ E⁰=1.23 V vs. SHE.

The first single-electron step of this reaction involves the abstraction of hydrogen which is given by the equation:

2H₂O+h⁺→OH(radical)+H₃O⁺ E⁰=2.848 V vs. SHE.

This translates to a free energy change of 275 kJ/mol for the 1-hole formation of the hydroxyl radial from water at pH 0. This is in comparison to an average of 119 kJ/mol per hole for the complete concerted reaction. If instead of the formation of a single hydroxyl radical, two neighboring water molecules are simultaneously singly-oxidized and thus allowed to regain a large portion of the energy cost by forming an O—O bond, we have the 2-electron concerted formation of peroxide, described by the following equation:

4H₂O+2h⁺→H₂O₂+2H₃O⁺

E⁰=1.776 V vs. SHE.

The lowering of voltage necessary to drive the reaction with a two electron concerted process versus stepwise single electron processes is rather dramatic and underscores the need to drive this reaction with concerted multiple charges in order to increase the overall efficiency of the device.

The system should furnish the electrons/holes with the requisite potentials (V_{red} and Vₒₓ) to the site where final reduction/oxidation reactions proceed. Furthermore, the site should make the reaction kinetically feasible. This will most likely require that the surface be catalytically active with respect to the desired reaction since most fuel producing half reactions are slow and may only occur at reasonable rates with the application of high overpotentials. This may require that the reaction take place at the interface of another material, known as a co-catalyst, which has been deposited on the semiconductor surface. The overpotential is the difference between the half-reaction's thermodynamic redox potential and the experimentally observed reaction potential. The application of a high overpotential to drive a reaction can be troublesome since at this higher potential other reactions may become energetically accessible, potentially resulting in the reduction of the yield of fuel production or even the destruction of the reaction site. The reduction and oxidation sites should be spatially well resolved to avoid back-reactions and charge recombination.

### Semiconductor Solar Cells

The earliest solar cells were based on semiconductors. In the classic p-n or p-i-n structures, the photo-generated charge carriers, namely the electron and hole, are swept apart by the internal built-in potential between an n-doped semiconductor and a p-doped semiconductor. The separated charges then flow through an external circuit to provide electricity.

Bulk semiconductors with sensitizers are also used for solar energy to electricity conversion. In these cells, also known as Gratzel cells, the light is absorbed by the sensitizer (dye molecule) creating a photo-excited electron and hole. The photo-excited electron travels to the conduction band of the semiconductor (TiO₂ in a Gratzel cell) while the photo-excited hole on the dye molecule then migrates into the electrolyte.

Semiconductors also play prominent roles in direct conversion of solar energy to chemical energy. The electron-hole pairs created by photons can promote local chemical reactions near the semiconductor surface. One example is that of water splitting. Hydrogen generation at the semiconductor/liquid interface has been among the most successful of these efforts. Several semiconductor materials, such as SrTiO₃ and other metal oxides, have been shown to produce hydrogen under sunlight without an additional electrical bias, but these materials only absorb light in the UV region.

Photoelectrochemical cells based on heterogeneous reactions at the surface of a bulk semiconductor can have several problems such as:

1. Difficult to find a single semiconductor material that has the combination of a reasonable band gap and proper locations for the band edge states;

2. A low surface area for interfacial redox reactions;

3. The diffusion lengths for created charges can be long during which the charge carriers can interact with other carriers and defects;

4. Fast charge recombination;

5. Materials that can act as a co-catalyst for one redox half-reaction are often not an appropriate co-catalyst for the other half-reaction.

It is very difficult to find a single semiconductor material that fits all the energetic requirements for the photoelectrochemical production of a chemical fuel. This has led to the development of multi-bandgap photoelectrochemical systems, known as tandem cells. In these cells, the free energy needed to drive the production of the chemical fuel comes not from the creation of a single exciton, but from the co-creation of multiple energetically staggered excitons. The overall effect is to create a single electron with enough potential to drive the reduction half-reaction and a single hole with enough potential to drive the oxidation. Since the free energy needed to drive fuel production comes from the absorption of photons in two different semiconductors, the bandgaps of these semiconductors can be appreciably smaller and thus engineered to better match the maximum insolation wavelengths.

### Semiconductor Nanocrystals

Nanocrystals are loosely defined as particles with small diameters ranging from a few hundred nanometers down to 1 nm or less. They are also known as nanoparticles, quantum dots, quantum spheres, quantum crystallites, colloidal particles, nano-clusters, Q-particles or artificial atoms. Due to their small size, they can possess dramatically different physical properties compared to their bulk counterparts. Nanoparticles have a wide range of applications, from metallurgy to chemical sensors, in a variety of industries including: the pharmaceutical industry, the paint industry, and the cosmetics industry. Thanks to the rapid development of synthetic methods in the last two decades, these materials have now entered into microelectronic and optical applications. Nanoparticles of a variety of semiconductors have been successfully synthesized.

Semiconductor colloidal nanocrystals are chemically synthesized, nanometer-sized, single crystals of semiconductor with ligands on the surface to afford dispersibility and stability in solution. The basic chemical synthetic route consists of reacting the component precursors of the semiconductor crystal in the presence of a stabilizing organic ligand. Varying the size of the nanocrystals can often be achieved by changing the reaction time, reaction temperature profile, or the ligands used to passivate the surface of the nanocrystals during growth. The chemistry of the ligand can control several of the system parameters, such as the growth rate, the shape, the dispersibility of the nanocrystals in various solvents and solids, and even the excited state lifetimes of charge carriers in the nanocrystals. The flexibility of this chemical synthesis is demonstrated by the fact that often one ligand is chosen for its growth control properties and is later substituted out after synthesis for a different ligand in order to provide an interface more suitable to the application or to modify the optical properties of the nanocrystal. In addition to this colloidal route, other synthetic routes for growing semiconductor nanocrystals have been reported in the literature, such as high-temperature and high-pressure autoclave based methods, as well as traditional routes using high temperature solid state reactions and template-assisted synthetic methods.

In nanocrystals, upon photo-excitation, an electron-hole pair (an exciton) is created, just as in bulk semiconductors. If the nanocrystal size is comparable to or smaller than the characteristic separation distance of the charge carriers in the bulk material (known as the Bohr radius) then the carriers are said to be confined by the nanocrystal. Nanocrystals with confined charge carriers can display a blue shifted band edge adsorption and emission that are size tunable (the magnitude of the shift goes as 1/R², where R is the nanocrystal radius) and can exhibit a structured absorption spectrum owing to well separated electron and/or hole states.

Using nanocrystals in a solar electrochemical cell can increase the efficiency and reliability of photoelectrochemical cells. All photo-generated charge carriers are created near the surface of the nanocrystal where the chemistry can occur. This reduces the losses incurred when charge carriers have to travel long distances where they can interact with other charge carriers and crystal defects. By using nanocrystals in a photoelectrochemical device, the surface area of the semiconductor available for interfacial chemistry is several orders of magnitude larger versus bulk semiconductors. Semiconductor colloidal nanocrystals are dispersible in solvents and films, allowing for an absorbing semiconductor with high number density and low scattering. Nanocrystals smaller than 10% of the wavelength exhibit negligible scattering. Recent work in nanocomposites has shown that materials with high loading scatter less than would be predicted by Mie theory. This allows one to create devices which have high loading in order to absorb as much of the light from the solar spectrum as possible while losing only a minimal amount of photons to scattering. The confinement effect allows one the ability to tune the bandgap energy and the band edge locations over a certain range for a given choice of semiconductor. This may make it easier to find semiconductor materials that fit all the energy requirements laid out for the successful implementation of a solar photoelectrochemical cell.

### Description of an Example Non-Limiting Illustrative Coupled Nanocrystal Photoelectrochemical Cell

The coupled nanocrystal photoelectrochemical cell is a system to create chemical fuel by means of light driven redox chemistry. A basis for this example system is colloidal nanocrystals of two different semiconductors electrically and physically linked by a shared ligand (SL). Each nanocrystal 1-shared ligand-nanocrystal 2 (NC1-SL-NC2) unit can act as a nanoscale tandem photoelectrochemical cell. The photons can be absorbed by both semiconductor nanocrystals, creating excitons in each nanocrystal. In addition to utilizing the tandem scheme to ease the energetic requirements on the absorber, the use of nanocrystals may add a further degree of freedom, as the energy of the bandgaps can be tuned to the required energy by changing the size of the nanocrystals due to the quantum confinement effect.

In a coupled nanocrystal photoelectrochemical cell, the free energy necessary to drive the surface reactions comes from the absorption of two photons by two different semiconductors, as opposed to the absorption of a single photon by a single semiconductor as in a more traditional photoelectrochemical cell. Ultimately, the electrons excited into the conduction band of NC1 are used in a reduction reaction at the surface of the NC1, while the holes in the valence band of NC2 are used for a balancing oxidation reaction at the surface of NC2. The fuel of interest may be the product of either the reduction or oxidation reactions or the product of a subsequent reaction or series of reactions preformed on the light-induced redox products.

In the coupled nanocrystal photoelectrochemical system, the shared ligand should link NC1 and NC2 to facilitate electron transfer between nanocrystals. The photo-excited hole from NC1 can be rapidly trapped by the shared ligand, where it can recombine with the electron transferred from NC2, resulting in the rapid removal of both of these “unwanted” charge carriers from the nanocrystals. This removal should lead to longer lifetimes for the excited charge carriers left behind in the nanocrystals.

This approach may have several advantages that should allow it to convert sunlight into chemical energy much more efficiently than any previous design. These advantages include:
delivering long lived exited states so that the overall efficiency is not reduced due to charge recombination;
the removal of the unwanted charges by the shared ligand to decrease the probability of unwanted side reactions occurring;
the ability to store and simultaneously deliver multiple charges in a concerted process to drive multi-charge redox reactions which not only improves system stability due to the use of lower energy excited states that are inherently more stable, but also uses the light energy in a more efficient manner since concerted multi-charge processes often have a lower free energy cost per electron than a series of single electron steps; and
a better use of the available solar spectrum due to the fact that this system utilizes two lower energy photons (which are more plentiful in sunlight incident upon the earth's surface) as opposed to a more traditional cell using a single high energy photon to drive the redox reactions.

### BRIEF DESCRIPTION OF THE DRAWINGS

These and other features and advantages will be better and more completely understood by referring to the following detailed description of non-limiting example illustrative embodiments in conjunction with the drawings, of which:

FIG. 1 shows an inefficient example charge separation, E_{g}=band gap energy, E_{c}=conduction band energy, Eᵥ=valence band energy, Vₒₓ=oxidation potential for fuel production step, V_{red}=reduction potential for fuel production step, filled circles=electrons, open circles=holes.

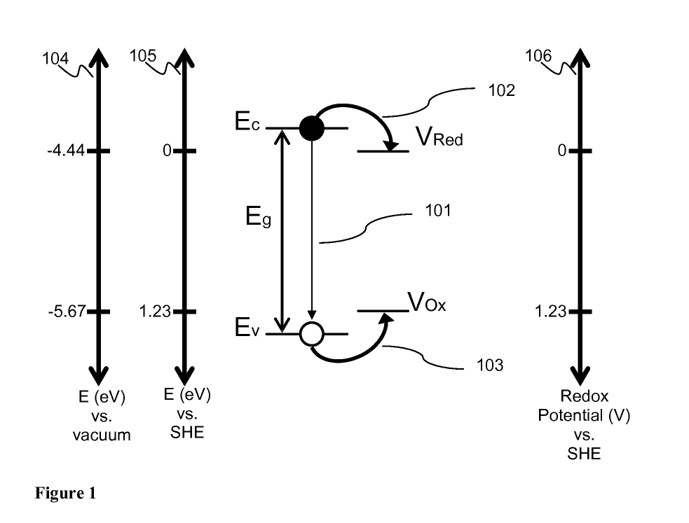

FIG. 2 shows a more efficient example charge separation, A=electron acceptor, D=electron donor (hole acceptor), E_{g}=band gap energy, E_{c}=conduction band energy, Eᵥ=valence band energy, Vₒₓ=oxidation potential for fuel production step, V_{red}=reduction potential for fuel production step, filled circles=electrons, open circles=holes.

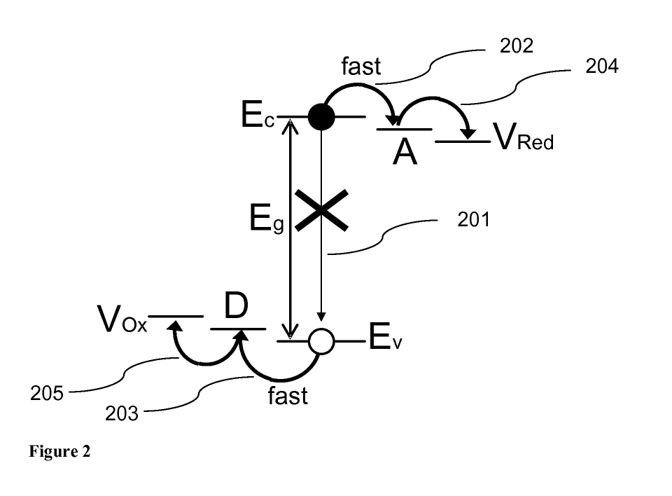

FIG. 3 is a conceptual drawing of an example illustrative non-limiting coupled semiconductor nanocrystal photoelectrochemical system. NC1 and NC2 are nanocrystal one and nanocrystal two, respectively. SL=shares ligand, filled circles=electrons, open circles=holes.

FIG. 4 shows the energy level diagram of an example illustrative non-limiting coupled semiconductor nanocrystal photoelectrochemical system during the absorption of two photons (a) and the subsequent steps leading to and including the redox reactions (b). NC1 and NC2 are nanocrystal one and nanocrystal two, respectively. SL=shares ligand, Vₒₓ=oxidation potential, V_{red}=reduction potential, filled circles=electrons, open circles=holes. Arrows show the direction of electron transfer.

FIG. 5 shows an exemplary non-limiting illustrative flow diagram for a possible route for making the coupled semiconductor photoelectrochemical system. NC1 and NC2 are nanocrystal one and nanocrystal two, respectively. L1 and L2 are the ligands that cover the surface of the nanocrystals after synthesis. SL1 and SL2 are ligands which can be linked together to form the shared ligand (SL).

FIG. 6 shows a cross-section of an exemplary illustrative non-limiting coupled semiconductor photoelectrochemical network for splitting water.

### DETAILED DESCRIPTION OF NON-LIMITING ILLUSTRATIVE EMBODIMENTS

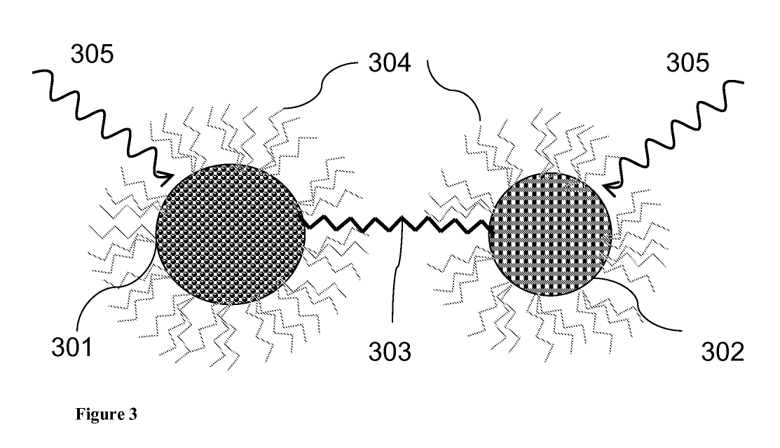

FIG. 3 shows an example non-limiting illustrative coupled nanocrystal photoelectrochemical cell. In this unit two different nanocrystals, nanocrystal 1 (301) and nanocrystal 2 (302) are linked through a shared ligand (303). In addition to the shared ligand, there may be other ligands or capping agents on the surfaces of the nanocrystal 1 and nanocrystal 2. These ligands (304) may be the same or different for each nanocrystal. Both nanocrystals absorb photons (305) from sunlight.

One exemplary non-limiting illustrative embodiment provides a photoelectrochemical system based on colloidal nanocrystals of two different semiconductors, nanocrystal 1 (NC1) and nanocrystal 2 (NC2), coupled by a “shared ligand” (SL) as shown in FIG. 3 to produce chemical energy.

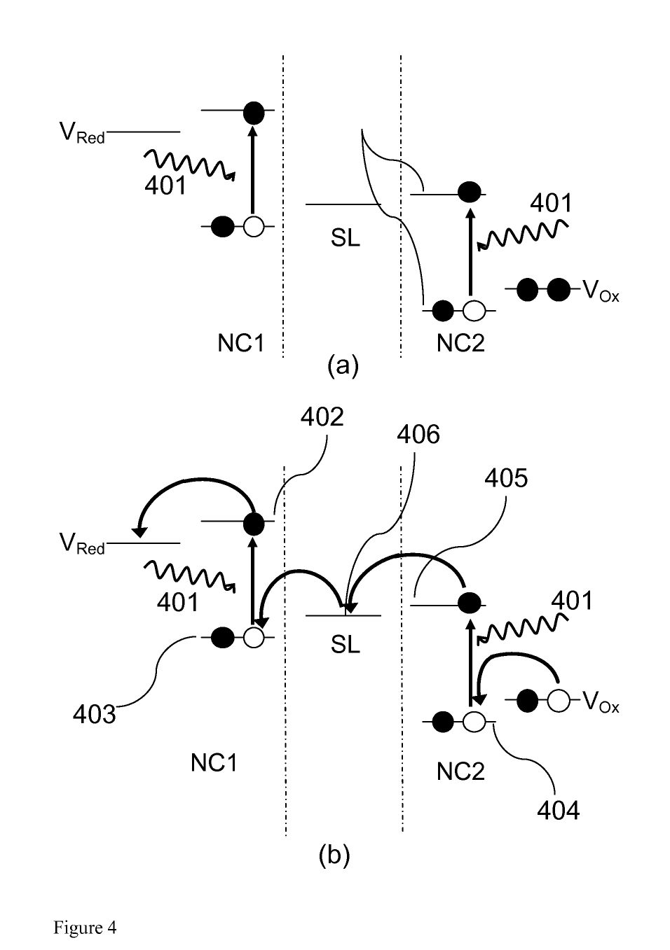

FIGS. 4a and 4b show an example illustrative non-limiting energy level diagram for a coupled nanocrystal photoelectrochemical cell. Photons (401) with energy greater than the band gap of the respective nanocrystals, can be absorbed by both nanocrystals (NC1 and NC2) creating an exciton in each nanocrystal as shown in FIG. 4a. Excitons are created by the excitation of an electron from the valence band of the nanocrystal into the conduction band. The energy of the absorbed photons may be the same or different for each nanocrystal. FIG. 4b illustrates the movement of electrons from the conduction band of NC1 to be used in the reduction reaction (which occurs at the redox potential, V_{red}). Meanwhile the holes on NC2 may be utilized for the balancing oxidation reaction (which occurs at the redox potential, Vₒₓ). FIG. 4b also demonstrates how the “unwanted” excited charge carriers (electrons in the conduction band of NC2 and holes in the valence band of NC1) may be rapidly trapped by the shared ligand, where they may later recombine with the opposite excited charge carriers from the other NC, resulting in the rapid removal of both “unwanted” charge carriers from the nanocrystals. Due to this removal of the photo-excited hole from NC1 and the photo-excited electron from NC2, the lifetimes of the excited electron in NC1 and the excited hole in NC2 may be longer. This may increase the likelihood of redox reactions occurring.

FIGS. 4A, 4B illustrates the relative positions of the energy levels of the coupled nanocrystal photoelectrochemical cell and the redox reactions. For the electron in the conduction band of NC1 to carry the heterogeneous reduction reaction at the surface of the nanocrystal, the conduction band edge of NC1 (402) should lie above the reduction potential (V_{red}). To allow hole transfer from the NC2 to the species that will be oxidized, the valence band potential of NC2 (404) should lie below the oxidation potential (Vₒₓ) of the species. In addition, the shared ligand should have an available energy level or levels (406), to facilitate electron transfer from the conduction band of the NC2 (405) to the valence band of NC1 (403). In energy terms, this level (406) should lie between the conduction band of NC2 (405) and the valence band of NC1 (403). This means that the conduction band of NC2 (405) should lie above the valence band of NC1 (403), resulting in a staggered conformation of band energies as show in FIG. 4b. Having the shared ligand trap the unwanted charge carriers quickly and efficiently may allow for long-lived excited states for the remaining charge carriers and consequently higher efficiency in carrying out the redox reactions.

An exemplary non-limiting illustrative embodiment provides using a coupled nanocrystal based photoelectrochemical cell that produces syngas, a mixture of carbon monoxide and molecular hydrogen, from the abundant and readily available reactants, water and carbon dioxide. In an example non-limiting coupled nanocrystal based solar electrochemical system, the nanocrystals act as the photon absorber. Photons are absorbed by both nanocrystals and two separate excitons are created. The excited electrons on nanocrystal 1 (NC1) may be used for the reduction half-reactions. To allow electron transfer from the NC1 to the fuel source that will be reduced, the conduction band potential of NC1 should lie above the fuel production potential. Both syngas producing reactions (the production of H₂ from H₂O and the production of CO from CO₂) display a pH dependant reduction potential. The fuel producing reduction half reactions and their reduction potentials (E⁰′) vs SHE at pH=7 are listed below:

2H⁺2e⁻→H₂ E⁰′=−0.41V

CO₂+2H⁺+2e⁻→CO+H₂O E⁰′=−0.52V.

Note that on many catalytic surfaces in water the production of H₂ from H₂O and the reduction of CO₂ to CO can occur simultaneously. This syngas could then be used as feedstock in the Fischer-Tropsch process to produce hydrocarbon fuel.

To allow hole transfer from NC2 to the species that will be oxidized, the valence band potential of NC2 should lie below the oxidation potential of the species. For example, redox potential for converting water into O₂ is 1.23V vs. SHE at pH=0, and 0.82V vs SHE at pH=7, for O₂ production as shown in the equation below:

2H₂O→O₂+4H⁺+4e⁻ E⁰′=0.82V.

In addition, the shared ligand should have an available energy level for the electron transfer from the conduction band of NC2 to the valence band of NC1. The potential of this level should lie between the conduction band potential of NC2 to the valence band potential of NC1.

Another exemplary non-limiting illustrative embodiment provides immersing this coupled nanocrystal electrochemical system into water and bubbling CO₂ into this solution and shining sunlight on the solution to generate H₂, CO and O₂ gases and collecting and separating these gases from each other.

Another exemplary non-limiting illustrative embodiment provides flowing water saturated with CO₂ over this coupled nanocrystal electrochemical system and shining sunlight on the solution to generate H₂, CO and O₂ gases and collecting and separating these gases from each other.

Another exemplary non-limiting illustrative embodiment provides collecting the product gases (H₂, CO and O₂) together and separating them from each other later.

Another exemplary non-limiting illustrative embodiment provides separating H₂, CO and O₂ gas as they are produced.

Another exemplary non-limiting illustrative embodiment provides using a coupled nanocrystal based photochemical cell that sequesters carbon dioxide, CO₂, from the atmosphere and converts it to carbon monoxide, CO.

Another exemplary non-limiting illustrative embodiment provides using a coupled nanocrystal based photochemical cell that sequesters carbon dioxide, CO₂, from the atmosphere and converts it into fuels. Some of the fuel producing reduction half reactions involving CO₂ as a reactant are shown below, along with their reduction potentials (E⁰′) vs SHE at pH=7:

2H⁺+2e⁻→H₂ E⁰′=−0.41V

CO₂+2H⁺+2e⁻→CO+H₂O E⁰′=−0.52V

CO₂+2H⁺+2e⁻→HCOOH E⁰′=−0.61 V

CO₂+4H⁺+4e⁻→HCHO+H₂O E⁰′=−0.48 V

CO₂+6H⁺+6e⁻→CH₃OH+H₂O E⁰′=−0.38V

CO₂+8H⁺+8e⁻→CH₄+2H₂O E⁰′=−0.24V

Another exemplary non-limiting illustrative embodiment provides using a coupled nanocrystal based photochemical cell that splits water into molecular hydrogen and molecular oxygen. The standard redox potentials for the two half reactions involved in the splitting of water are 1.23 V vs. the standard hydrogen electrode (SHE) for the oxidation of water to oxygen, and 0.0 V vs. SHE for the reduction of water to hydrogen. The energetic requirements for the coupled nanocrystals dictate that the conduction band edge of the semiconductor NC1 should lie energetically above 0.0 V vs. SHE and the valence band edge of the NC2 should lie below 1.23 V vs. SHE. These values display a strong dependence on pH as well as a dependence on other properties of the solution and surface at which the reaction is taking place.

One exemplary non-limiting illustrative embodiment provides immersing this coupled nanocrystal electrochemical system into water and shining sunlight on the solution to generate H₂ and O₂ gases and collecting and separating these gases from each other.

Another exemplary non-limiting illustrative embodiment provides flowing water over this coupled nanocrystal electrochemical system and shining sunlight on the solution to generate H₂ and O₂ gases and collecting and separating these gases from each other.

Another exemplary non-limiting illustrative embodiment provides collecting the product gases (H₂ and O₂) together and separating them from each other at a later time.

Another exemplary non-limiting illustrative embodiment provides separating H₂ gas as it is produced.

Another exemplary non-limiting illustrative embodiment provides using a coupled nanocrystal based photochemical cell that generates hydrogen gas from water. This method allows for H₂ production without using fossil fuel and generating environmentally hazardous materials, such as CO₂. Unlike some other methods, such as thermochemical water splitting processes that require high temperatures (>750° C.), a coupled nanocrystal based photoelectrochemical cell can produce H₂ at lower temperatures (<100° C.), even at room temperature.

Another exemplary non-limiting illustrative embodiment provides having coupled nanocrystals in a solar photoelectrochemical cell where the properties of each component can be adjusted separately. The confinement effect allows one the ability to tune the bandgap energy and the band edge locations over a certain range for a given semiconductor nanocrystal, making it easier to find a semiconductor material that can fit all the energy requirements for desired reactions.

One exemplary non-limiting illustrative embodiment provides the semiconductor material for NC1 having a bandgap between 0.4-4 eV, preferably between 0.8-3.3 eV and more preferably between 1-1.5 eV.

One exemplary non-limiting illustrative embodiment provides examples of the semiconductor materials for NC1 for a photoelectrochemical device. These examples of NC1 include, but are not limited to: (bandgap energies, when available, are given in parentheses): TiO₂-anatase, (3-3.2 eV), TaON (2.5 eV), Ta₃N₅ (2.1 eV), Sm₂Ti₂S₂O₅ (1.9-2.1 eV), LaTiO₂N (2.1 eV), SrTiO₃(Cr—Ta doped), In₂Zn₉O₁₂, InNbO₄, Cu₂O (2.0 eV), GaAs (1.4 eV), GaP (2.25 eV), and InTaO₄ (2.6 eV).

One exemplary non-limiting illustrative embodiment provides a semiconductor material for NC1 with conduction band edge above to 0.0 eV vs SHE in order to drive the reduction of water into H₂.

One exemplary non-limiting illustrative embodiment provides the semiconductor material for NC2 having a bandgap between 0.4-4 eV, preferably between 0.8-3.3 eV and more preferably between 1-1.5 eV.

One exemplary non-limiting illustrative embodiment provides examples of the semiconductor materials for NC2 for a photoelectrochemical device. These examples of NC2 include, but are not limited to: (bandgap energies, when available, are given in parentheses): TiO₂-rutile (3-3.2 eV), WO₃ (2.7 eV), Ta₃N₅ (2.1 eV), TaON (2.5 eV), Sm₂Ti₂S₂O₅ (1.9-2.1 eV), LaTiO₂N (2.1 eV), WO₃, In₂O₃, Bi₂O₃, Fe₂O₃, BiVO₄, CuWO₄, NiWO₄, SrWO₄.

One exemplary non-limiting illustrative embodiment provides the semiconductor material for NC2 having valence band edge below 1.23 eV vs SHE for the oxidative production of O₂ from water.

Another exemplary non-limiting illustrative embodiment provides having either one of, or both, NC1 and NC2 in the quantum confinement regime to help tune the valence and conduction band edge locations for better energetic overlap with the states of the shared ligand or with the redox potentials necessary to drive the fuel producing reactions, in order to enhance electron or hole transfer. Semiconductor nanocrystals are said to be in the confinement regime if their diameter is the same size or smaller than the Bohr radius of the exciton in the bulk semiconductor. This confinement has the effect of increasing the effective bandgap of the semiconductor, while moving the locations of the band edges.

Another exemplary non-limiting illustrative embodiment provides having either one, or both NC1 and NC2 in the quantum confinement regime to help increase the spatial overlap between the valence/conduction band edge states and the states of the shared ligand or with the sites where the redox fuel producing reactions occur, resulting in enhanced electron or hole transfer to the reactants. Semiconductor nanocrystals are said to be in the confinement regime if their diameter is the same size or smaller than the Bohr radius of the exciton in the bulk semiconductor. This confinement has the effect of increasing the probability of the charge carriers being at or near the surface of the semiconductor nanocrystals. In quantum confined particles the electron and hole wave functions can extend beyond the edge of the nanocrystal resulting in better spatial overlap with the shared ligand or with states in the species that are to undergo the redox reactions.

Another exemplary non-limiting illustrative embodiment provides coupled nanocrystals acting as the catalytic surface in addition to the photon absorption. In a coupled nanocrystal based electrochemical cell all photo-generated charge carriers are already near the surface of the nanocrystals where the chemistry can occur. Once the long-lived, high-energy charge carriers are on the surface of the nanocrystals, the redox chemistry can occur to produce the chemical fuel. The surface reaction site should make the reaction kinetically feasible for there to be efficient fuel production. The semiconductor surfaces can act as a catalyst for the redox reactions in several ways, for example: by aggregating multiple charges at the reaction site, by aiding the alignment of the reactants in the correct geometry for the redox reaction, or by various other means. In addition, the shape of the nanocrystals can improve their catalytic activity. Changes in shape exposes different facets as reaction sites and changes the number and geometry of step edges where reactions may preferentially take place. Nanocrystals can be spheres, rods, triangles, tetrapods, tubes, flakes, discs, irregular shapes with step edges, wires, etc.

Another exemplary non-limiting illustrative embodiment provides a coupled nanocrystal photoelectrochemical system with either one, or both, of NC1 and NC2 having at least one kind of co-catalyst on the surface to promote the efficiency of the redox reactions. Early studies in photocatalysis demonstrated that semiconductor surfaces, upon which noble metals (Pd, Pt, and Ir) had been deposited, demonstrated enhanced photocatalytic activity. The deposited noble metal appears to act as a reservoir for the electrons generated by the absorption of the photon. This, in turn, promotes the charge-transfer process at the surface. Having a co-catalyst at the semiconductor surface is particularly important since without it, most semiconductors show a high overpotential for the production of H₂. Pooling of charges in the metal co-catalyst may be one of the reasons behind the increased photocatalytic activity of semiconductor surfaces. Since one feature of an example illustrative non-limiting design is to make it possible for the semiconductor nanocrystals NC1 and NC2 to have multiple excited charges simultaneously available for the redox reactions, it is possible to not use costly noble metals as co-catalysts. However, the co-catalysts on the surface may have the beneficial effect of making semiconductor surfaces more photostable toward corrosion.

More recently, photoelectrochemical researchers have used materials other than the noble metals to act as co-catalysts. In addition to the high cost of noble metals, there is also the fact that these metals can catalyze both the forward and the backward reaction under certain conditions. For the example of water-splitting, the production of water from hydrogen and oxygen is catalyzed by noble metals in addition to the desired production of hydrogen and oxygen. So, instead of noble metals, NiOₓ and RuO₂ are some of the most commonly used co-catalysts because they do not demonstrate activity for the formation of water from H₂ and O₂. The prevention of the backward reaction may prove to be a crucial consideration for choosing a co-catalyst for the production of fuel. Examples of co-catalysts for use on NC1 and NC2 include, but are not limited to: Pt, Pd, Ir, NiO, NiO₂, RuO₂, IrO₂, chromium oxide, and rhodium oxide.

Another exemplary non-limiting illustrative embodiment provides a coupled nanocrystal photoelectrochemical system with NC1 having at least one kind of co-catalyst on the surface to promote the efficiency of the reduction reaction. These co-catalysts can be other semiconductor materials, organic material, metals, or metal oxides. These catalysts can not only catalyze the surface reactions and reduce the overpotentials necessary to produce the fuel, but also may protect the semiconductor surface from corrosion.

Another exemplary non-limiting illustrative embodiment provides a coupled nanocrystal photoelectrochemical system with NC2 having at least one kind of co-catalyst on the surface in order to promote the efficiency of the oxidation reaction.

One exemplary non-limiting illustrative embodiment provides a conductive shared ligand that acts as a degenerate (or near degenerate) source of electrons and holes for recombination with the unwanted charge carriers in NC1 and NC2, thus acting as an electron and hole reservoir for the coupled nanocrystals. The degeneracy (or near degeneracy) would allow for the possible co-existence of several excited charges on a single nanocrystal, electrons on NC1 and holes on NC2. In an isolated nanocrystal, after the absorption of a single photon to create an electron-hole pair, the further absorption of a photon creates a bi-exciton. The lifetime of this bi-exciton is dramatically shorter than the lifetime of a single exciton. This means that there is very little chance for a multi-electron concerted redox reaction to take place on the surface of an isolated nanocrystal. A major advantage of this NC1-SL-NC2 system is that after the creation of the exciton and migration of the unwanted charge carrier to the degenerate shared ligand, the absorption of another photon does not result in a short lived bi-exciton state; rather, it creates another usable excited charge carrier. This process can also occur where the shared ligand is not a source of multiple degenerate (or near degenerate) electrons or holes, but it is less likely since it requires a balance of charges being created on the other end of SL.

Another exemplary non-limiting illustrative embodiment provides a NC1-SL-NC2 system which furnishes multiple charges to the redox reaction sites in order to drive the redox reactions as multi-charge concerted reactions. The ability to store and simultaneously deliver multiple charges in a concerted process to drive multi-charge redox reactions not only improves system stability due to the use of lower energy excited states that are inherently more stable but also uses the light energy in a more efficient manner since concerted multi-charge processes often have a lower free energy cost per electron than a series of single electron steps.

Another exemplary non-limiting illustrative embodiment provides a shared ligand that includes a transition metal center that acts as a degenerate source of electrons and holes for recombination with the unwanted charge carriers of NC1 and NC2, acting as an electron and hole reservoir for the coupled nanocrystals. This metal center may be in the middle of the shared ligand or closer to NC1 or NC2.

Another exemplary non-limiting illustrative embodiment provides NC1 and NC2 being made of semiconductor materials and having bandgaps small enough to absorb the visible light. The efficiency of the solar electrochemical cell will depend on the amount of the solar radiation absorbed. Nearly 50% of the solar radiation that reaches the surface of the earth is in the visible range, whereas the UV region of the solar spectrum (where the majority of semiconductor PEC devices absorb light) only makes up approximately 4% of insolation.

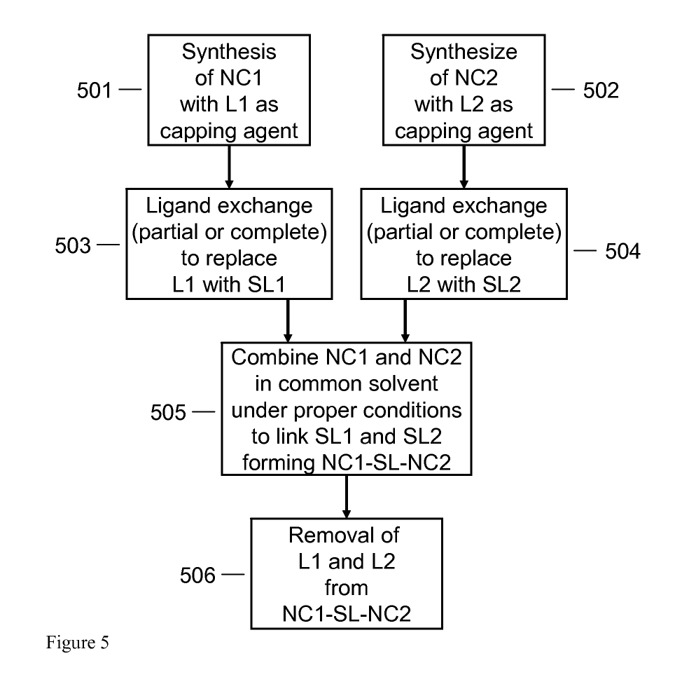

Another exemplary non-limiting illustrative embodiment provides forming the NC1-SL-NC2 unit by combining two basic subunits, NC1 with the first half of the shared ligand (SL1) and NC2 with the other half of the shared ligand (SL2). A block flow diagram illustrating this formation scheme is shown in FIG. 5. SL1 and SL2 will have functional groups, R1 and R2 for SL1 and R3 and R4 for SL2, on both ends. R1 and R3 can connect to the surfaces of NC1 and NC2, respectively (See equations 1 and 2). During the synthesis of nanocrystals, ligands or capping agents are used to stabilize the nanocrystals and allow for dispersibility in a common solvent. Therefore during synthesis, both NC1 and NC2 may be capped with ligands, L1 (501) and L2 (502), respectively. The reactions in equations 1 and 2, shown below, can be carried out by ligand exchange reaction where some, or all, of the ligand L1 on NC1 can be replaced with SL1 (503) and some, or all, of the ligand L2 on NC2 can be replaced with SL2 (504). Alternatively, NC1 and NC2 may have less than a full coverage by ligands L1 and L2 or even no coverage of ligands L1 and L2, R1 and R3 may form bonds with the surface groups on NC1 and NC2, respectively, binding SL1 to NC1 and SL2 to NC2. SL1 and SL2 may be bound to NC1 and NC2 with a variety of different types of chemical bonds including: van der Waals attraction, ionic bonding, and covalent bonding, resulting from a variety of reactions including: elimination reactions, condensation reactions, nucleophilic substitutions, electrophilic substitutions and electrostatic interactions.

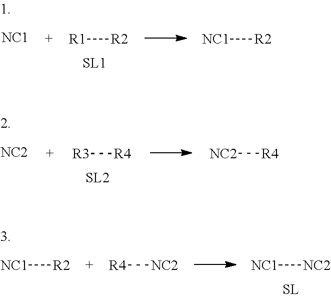

Full and partial ligand exchanges of L1 with SL1 and L2 with SL2 can be achieved by engineering the functional groups, R1 and R3, which can attach the various ligands to the nanocrystals for complete or competitive equilibration of ligand coverage. This control over the fractional coverage of NC1 and NC2 by SL1 and SL2, respectively, can serve as a method to control the number of nanocrystals that attach to each other, i.e. how many NC2s attach to a NC1 nanocrystal or vice versa, or as a way to control the stoichiometry in a 3-dimensional network of coupled nanocrystal photoelectrochemical units.

The sub-units, SL1 and SL2, can also have other functional groups, R2 for SL1 and R4 for SL2, so that upon the combination of NC1 and NC2 in solution, the basic binary complex can be formed by the creation of a covalent linkage between SL1 and SL2 by the reaction of R2 with R4 (505). This can form the shared ligand, SL as show in equation 3 above. Covalent linkages between nanocrystals using this strategy have been shown previously to bind nanocrystals together. See e.g., R. Voggu, P. Suguna, S. Chandrasekaran, C. N. R. Rao. Chem. Phys. Lett. 443, 2007, 118. Some or all of L1 on NC1 and L2 on NC2 can be removed for easy passage of the reactants and products (506).

Another method to form the NC1-SL-NC2 complex could be by the bonding between NC1 and the R′ 1 group of shared ligand to form NC1-R′2 as show in equation 4 and then reacting R′2 with NC2 to form NC1-SL-NC2 as shown in equation 5. This method may require the use of protecting groups on the shared ligand. In the scheme shown here the protecting group would act to make the R′2 group unavailable for bonding with NC1. This protecting group would then be removed prior to exposure of the NC1-R′2 group to NC2. This method may also be applied in the reverse order, by forming the bond between NC2 and the shared ligand, first. This removal of the protecting group may be facilitated by a variety of methods ranging for photochemical processes to chemical reactions.

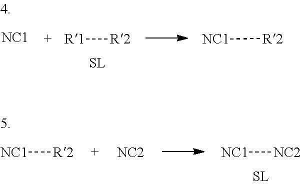

R1, R2, R3, R4, R′ 1 and R′2 can be the same functional group or they may be all different from each other. Examples of R1, R2, R3, R4, R′ 1 and R′2 include, but are not limited to: —H, —SH, —NH, —CH₃, —P, —C≡CH, —CH═CH₂, —COOH, —COH, —OH, —NH₂, —OCH₃, —OC₂H₅, —PO, —SO, —Br, —I, —Cl, —F, —CONH₂—COCl, —CH(NH₂)COOH. The body of the SL may contain conjugated hydrocarbons, non-conjugated hydrocarbons, cyclic groups, metal centers, metal centers with organic groups attached, combination of single, double, and triple bonds, etc.

Another exemplary non-limiting illustrative embodiment provides a shared ligand comprising conjugated organic molecules with functional groups on each side. Upon exposure to the nanocrystals, one end of this ligand can bond with the NC1 and the other end can bond with the NC2.

Another exemplary non-limiting illustrative embodiment provides a shared ligand comprising conductive molecules with functional groups on each side. One end of this ligand can bond with the NC1 and the other end can bond with the NC2.

Another exemplary non-limiting illustrative embodiment provides coupling of the nanocrystals in the above manner to form nanocrystal dimers, NC1-SL-NC2.

Another exemplary non-limiting illustrative embodiment provides coupling of the nanocrystals in the above manner to form a three dimensional network of these nanocrystals separated from each other by the shared ligand. One example of this type of 3-dimensional network system may be similar to that of metal-organic frameworks (MOFs).

The network may have several important advantages. In this network, SL may contain conjugated parts. A stiff shared ligand would keep the nanocrystals from shorting out with other nanocrystals in the network. This may prove necessary for the construction of an efficient system, since after photo-excitation and recombination of the unwanted charges in the shared ligand, the Coulomb attraction between the charged nanocrystals would pull them together and cause the charges which should do the work to produce chemical fuel to recombine, reducing the overall efficiency of the network. This network may result in an open face, rigid pore structure with access channels for redox reactants and the products.

Another exemplary non-limiting illustrative embodiment provides removing the ligands, L1 from NC1 and L2 from NC2, by surface treatment, after forming the network of NC1-SL-NC2 units. The ligands, L1 and L2 are no longer necessary for the dispersibility and stability of the individual nanocrystals once the network is formed. Removal of these ligands can increase the surface area of the nanocrystals available for the fuel producing redox reactions. The resulting increase in interfacial area available for fuel production in this system versus a more traditional bulk semiconductor surface would be dramatic and result in a higher fuel production rate.

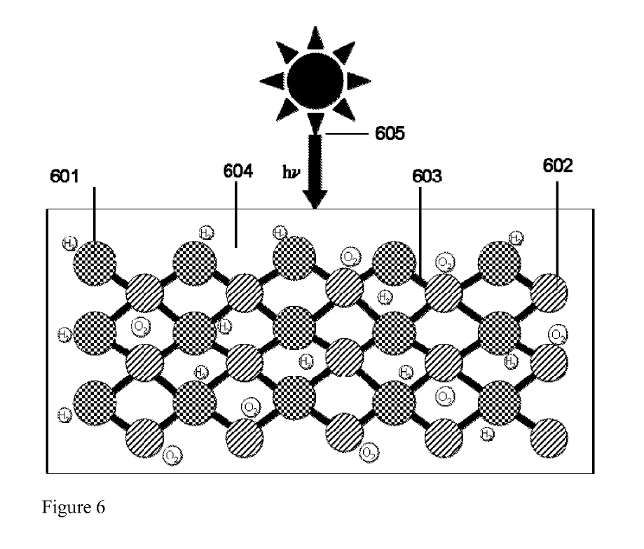

FIG. 6 shows an example non-limiting illustration representing a cross-section of a nanocrystal network designed to split water. The network is formed by linking nanocrystal 1 (601) and nanocrystal 2 (602) by shared ligand (603) in three dimensions. This matrix is inserted into water (604). Sunlight (605) with energy hv, incident upon the container filled with water and the photoelectrochemical network, causes H₂ to be produced at the surfaces of nanocrystal 1 while O₂ is generated at the surfaces of nanocrystal 2. In this example the ligands L1 and L2 have been removed to allow for a larger nanocrystal/water interface and to create channels for the water and the photo generated H₂ and O₂ to permeate the network. The resulting porous network should allow for the transmission of water and photogenerated H₂ and O₂ throughout the network.

Another exemplary non-limiting illustrative embodiment provides for the coupled nanocrystal photoelectrochemical cell to be placed in series with a UV absorbing photoelectrochemical cell in a sandwich-type configuration where the UV absorbing cell is placed above (between the coupled nanocrystal photoelectrochemical cell and the sun). This cell may serve either or both of the two following purposes: to act as a UV filter for the coupled nanocrystal photoelectrochemical cell and to make more efficient use of the UV radiation for the production of chemical fuel.

When a semiconductor absorbs a photon with energy above the bandgap, there is a brief period of time (<1 ps in semiconductor nanocrystals) where the electrons lie in states which are energetically above the conduction band edge and the holes lie in states which are energetically below the valence band edge. The charge carriers then thermalize with the solid and lose their excess energy and fall to the conduction band edge in the case of the photoexcited electron and the valence band edge in the case of the photoexcited hole. These “hot” charge carriers can thus electrochemically access reactions that the thermalized carriers cannot. Especially of concern is the site where the oxidation occurs (the surface of NC2) since holes in energy levels below the redox potential necessary to oxidize water are usually capable of oxidizing many other chemicals or even the semiconductor itself. For example the following half-reaction which occurs in aqueous solution with a pH of 0:

2ZnO+4h⁺→2Zn²⁺+O₂ E⁰=0.9 V vs SHE,

is readily accessed by photo-generated holes in ZnO and may lead to the decomposition of the semiconductor (h+=hole). Thus for the coupled nanocrystal photoelectrochemical cell, which is designed to make use of visible or near UV light it is helpful to have something filter the UV radiation.

Another exemplary non-limiting illustrative embodiment provides a coupled nanocrystal photoelectrochemical cell that only utilizes pure solvent and reactants along with the coupled nanocrystals to produce the chemical fuel. For the splitting of water this would include just water and for the cell producing syngas this would include water and CO₂.

Another exemplary non-limiting illustrative embodiment provides a coupled nanocrystal photoelectrochemical cell that utilizes pure solvent and reactants and an electrolyte (or electrolytes) along with the coupled nanocrystals to produce the chemical fuel.

While the technology herein has been described in connection with exemplary illustrative non-limiting implementations, the invention is not to be limited by the disclosure. The invention is intended to be defined by the claims and cover all corresponding and equivalent arrangements whether or not specifically disclosed herein.

1. A photoelectrochemical cell comprising:
a first nanocrystal,
a second nanocrystal, and
a shared ligand linking said first nanocrystal to said second nanocrystal.

2. A method of claim 1 wherein at least one of said first nanocrystal and said second nanocrystal has a bandgap.

3. A method of claim 1 wherein at least one of said first nanocrystal and said second nanocrystal is a semiconductor.

4. A method of claim 1 wherein at least one of said first nanocrystal and said second nanocrystal absorbs at least visible light.

5. A method of claim 1 wherein at least one of said first nanocrystal and said second nanocrystal absorbs at least ultraviolet light.

6. A method of claim 1 wherein said shared ligand chemically bonds to at least one of said first nanocrystal and said second nanocrystal.

7. A method of claim 1 wherein said shared ligand comprises a conjugated molecule.

8. A method of claim 1 wherein said shared ligand comprises a non-conjugated molecule.

9. A method of claim 1 wherein said shared ligand comprises a metal center.

10. A method of claim 1 wherein said first nanocrystal comprises a compound selected from the group consisting of TiO₂-anatase, TaON, Ta₃N₅, Sm₂Ti₂S₂O₅, LaTiO₂N, SrTiO₃ (Cr—Ta doped), In₂Zn₉O₁₂, InNbO₄, Cu₂O, GaAs, GaP, and InTaO₄.

11. A method of claim 1 wherein said second nanocrystal comprises a compound selected from the group consisting of TiO₂-rutile, Pt—WO₃, Ta₃N₅, TaON, Sm₂Ti₂S₂O₅, LaTiO₂N, WO₃, In₂O₃, Bi₂O₃, Fe₂O₃, BiVO₄, CuWO₄, NiWO₄, and SrWO₄.

12. A method of claim 1 wherein the band edge energy of the conduction band of said first nanocrystal is above the potential necessary to reduce the species that is to be reduced at the surface of the nanocrystal in the overall fuel production.

13. A method of claim 1 wherein the band edge energy of the conduction band of said first nanocrystal is above the potential necessary to reduce water.

14. A method of claim 1 wherein the band edge energy of the conduction band of said first nanocrystal is above the potential necessary to reduce CO₂.

15. A method of claim 1 wherein the band edge energy of the valence band of said second nanocrystal is below the potential necessary to oxidize the species that is to be oxidized at the surface of the nanocrystal in the overall fuel production.

16. A method of claim 1 wherein the band edge energy of the valence band of said second nanocrystal is below the potential necessary to oxidize water.

17. A method of claim 1 wherein the energy of the valence band edge of said first nanocrystal is below the conduction band edge of said second nanocrystal.

18. A method of claim 1 wherein said shared ligand having at least one energy level between the valence band edge of said first nanocrystal and the conduction band edge of said second nanocrystal.

19. A method of generating chemical fuel using a photoelectrochemical cell comprising:
(a) providing a coupled nanocrystal material comprising:
at least a first nanocrystal;
at least a second nanocrystal; and
a shared ligand linking said first nanocrystal to said second nanocrystal, thereby forming a coupled nanocrystal material;
(b) contacting said coupled nanocrystal material with a fuel source;
(c) shining sunlight onto said coupled nanocrystal material so that said coupled nanocrystal material absorbs said sunlight; and
(d) producing fuel in response to sunlight absorption by said coupled nanocrystal material.

20. A method of claim 19 wherein said fuel source is water.

21. A method of claim 19 wherein said fuel source is carbon dioxide

22. A method of claim 19 wherein contacting comprises; inserting, dipping, bubbling, and forming a solution.
